(19) United States
(12) Patent Application Publication
(10) Pub. No.: US 2007/0164704 A1
(43) Pub. Date: Jul. 19, 2007

(54) Plug with supplemental memory

(75) Inventors: James W. McGinley, Barrington, IL (US); Donald Rimdzius, Addison, IL (US)

Correspondence Address: SEYFARTH SHAW LLP, 131 S. DEARBORN ST., SUITE2400, CHICAGO, IL, 60603-5803, US

(73) Assignee: Horizon Technologies, Inc.

(21) Appl. No.: 11/331,863

(22) Filed: Jan. 13, 2006

(51) Int. Cl. H02J 7/00; H04B 1/38

(52) U.S. Cl. 320/114; 455/573

(57) ABSTRACT

A plug is provided that includes a charging circuit and a supplemental memory and the plug body includes an outer profile that is a compact size. The plug allows for data from a battery powered device to be written to the supplemental memory for emergency access by the battery powered device. The plug provides for the backup from a battery powered device such as a cell phone or personal digital assistant of data such as telephone numbers, addresses, calendars, ring-tones, video or music files.

The present application is a continuation-in-part of application Ser. No. 11/XXX,XXX [matter no. 400100] filed Dec. 28, 2005, and the present application is related to application Ser. No. 11/149,118 filed Jun. 8, 2005.

The present invention pertains to an electrical plug having a supplemental memory and a method of charging a battery-powered device.

### BACKGROUND

Chargers and power adapters are well known for charging the batteries of battery-powered devices, such as cellular telephones and personal digital assistants (PDA). Generally these chargers are “brick sized” components that are much larger than the standard electrical wall outlet receptacle. The components within these chargers that convert AC to DC and include a charging circuit, require a large amount of space and an outer profile that is large with respect to a standard electrical wall outlet. For example, a NEMA 5-15P outlet requires an outlet receptacle having a dimension of less than approximately 1¼×1¼ inch. Many known chargers have an outer profile that when plugged into the wall outlet, extend not only beyond the outer dimension of the standard wall outlet receptacle, but also encroach upon the receptacle dimension of the adjacent wall outlet.

Other types of charging units are known such as base stations or cradles, into which a cellular phone or PDA is mounted when not in use. While located in the. cradle, the cellular phone may be charged. It is also known for such base stations to have other functions, such as providing for memory storage and for determining the charging state of the battery of the cellular phone. Such base stations have microprocessors for interfacing with the cellular phone and providing communication interface circuitry in order to access components of the cellular phone such as memory, in order to update the base station. However, these base stations are not easily transportable, as they are fairly large and cumbersome in size. While these base stations are sufficient to be used in a person's home or at a place of work, they are not appropriate for travel and transport in a person's purse or briefcase.

A large amount of data such as telephone numbers, names and addresses are commonly collected on PDAs, cell phones, digital cameras and laptop computers. Such data is very valuable and sometimes hard to replicate or restore. In an emergency, during memory malfunction or if the cell phone is lost, there is desired a means to restore the data easily and quickly. Thus, there is desired a small charger that has an outer profile that is less than or equal to the outer dimension of a standard wall outlet that is easily transportable and automatically stores data from a battery powered device such as a cell phone or PDA to a supplemental memory.

### SUMMARY

The present invention provides for a plug for charging a battery powered (BP) device comprising a plug body having an outer profile and mounted within the plug body is a charging circuit and a memory for receiving data written from the BP device and power contact blades for connecting the charger to a standard electrical outlet including a face having a first dimension and the outer profile protruding generally perpendicular to the face, the outer profile being smaller than or equal to the first dimension.

In an embodiment, the plug may include a memory control circuit for controlling data written to the memory. In an embodiment, the BP device may be a cell phone that includes a host memory and a communication interface for writing data from the host memory to the memory of the plug. In an embodiment, the data may include telephone numbers, names and/or other data stored in a host memory of the battery powered device. In an embodiment, the BP device may include a communication interface that reads data from the memory. In an embodiment, the plug may include a memory control circuit and communication between the memory control circuit and the communication interface is wireless.

In an embodiment, the supplemental memory may be an EEPROM. In an embodiment, the plug may further comprise a cord and connector for connecting the charger to the BP device and the cord for carrying DC to a battery of the BP device and data to a communication interface of the battery powered device. In an embodiment, the face of the outlet may include a second dimension, and the first dimension and second dimension provide a peripheral dimension of the outlet face and the plug outer profile being smaller than or equal to the peripheral dimension.

In a further embodiment, the present invention provides for a method of charging a BP device comprising the steps of providing a host memory and battery in a BP device and a memory in a charger, grasping a plug body of the charger, substantially aligning an outer profile of the plug body with an outer dimension of a standard electrical outlet, connecting the charger to the standard electrical outlet by inserting blades of the plug body into the outlet so that the plug body outer profile does not extend beyond the outer dimension, attaching the charger to the BP device, transferring power from the charger to the battery and automatically transferring data from the host memory to the charger memory.

In an embodiment, the BP device may include a communication interface and the charger includes a memory control circuit and the method further comprising the steps of writing data to the memory control circuit via the communication interface and transmitting data to the memory via the memory control circuit. In an embodiment, the method may further comprise the step of converting AC or DC power from an electrical outlet or other power source to DC power via a power supply and providing battery charging power to the BP device. In an embodiment, the transfer of data from the host memory to the charger memory may occur independently from the charging operation.

In another embodiment, the invention provides for a cell phone charging system comprising a substantially standard sized electrical plug adapted to convert AC, supply DC, charge a cell phone battery, receive data from a data storage area of the cell phone and maintain data in a memory provided by the plug. In an embodiment, the plug may be adapted to connect to a standard electrical outlet having an outer dimension and the plug having a plug body substantially aligning with the outer dimension of the outlet. In an embodiment, the cell phone may include a communication interface for transmitting data to the memory of the plug. In an embodiment, the plug may include a printed circuit board (PCB) having a memory circuit, a memory control circuit and a charging circuit. In an embodiment, the memory circuit may include a non-volatile ROM or RAM. In an embodiment, an LED is disposed on the plug to indicate cell phone charging status or memory data transmission status. In an embodiment, the plug is adapted to connect to a vehicle electrical outlet in order to charge the cell phone from a battery of the vehicle.

In a further embodiment the invention provides for a charger for a battery powered (BP) device comprising a plug body having a front plate, a charging circuit and a memory disposed in the body, the memory for receiving data sent from the BP device and power contact blades protruding from the front plate, the power contact blades for connecting the charger to an electrical outlet. In an embodiment, the plug body, the front plate, charging circuit and memory may comprise an integral package having a compact size that may be grasped by a users hand in order to plug the charger into the electrical outlet. In an embodiment, the plug body may include an outer profile, the electrical outlet including a front face having a first dimension and the outer profile of the plug body does not extend substantially beyond the first dimension.

In an embodiment, the charge may further include a memory control circuit for controlling data written to the memory. In an embodiment, the memory may be a supplemental memory and the BP device is a cell phone that includes a host memory and a communication interface for writing data from the host memory to the supplemental memory of the charger. In an embodiment, the data may include telephone numbers, names, pictures, sound files, or other such data stored in a host memory of the BP device. In an embodiment, the BP device may include a communication interface that reads data from the memory.

In an embodiment, the charger may include a memory control circuit and communication between the memory control circuit and the communication interface is wireless. In an embodiment, the memory may be an EEPROM. In an embodiment, the charger may further comprise a cord and connector for connecting the charger to the BP device and the cord for carrying DC to a battery of the BP device and data to a communication interface of the BP device

### BRIEF DESCRIPTION OF THE DRAWINGS

For the purpose of facilitating an understanding of the invention, there is illustrated in the accompanying drawings an embodiment thereof, from an inspection of which, when considered in connection with the following description, the invention, its construction and operation, and many of its advantages should be readily understood and appreciated.

FIG. 1 is a perspective view of a charger plug and outlet system of the present invention;

FIG. 2 is a perspective view of the opposite side of the charger plug of FIG. 1; and

FIG. 3 is a functional block diagram of the charger plug system of the present invention.

### DETAILED DESCRIPTION

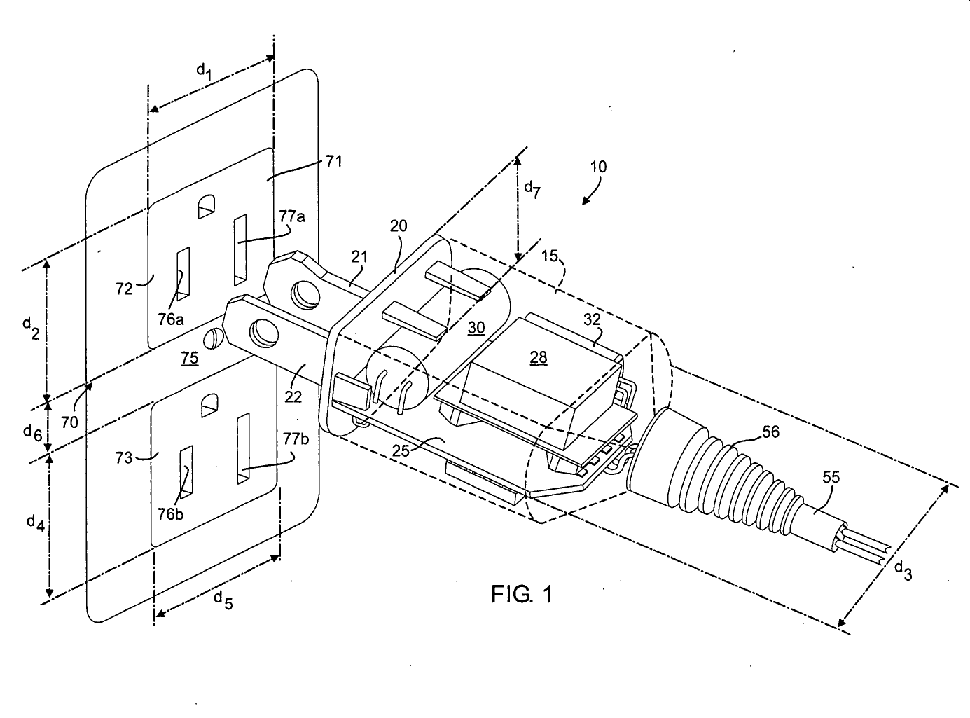

An embodiment of the present invention is depicted with respect to FIGS. 1-3. The invention pertains to a charging system and in particular a charger plug 10, circuit assembly or power adapter for charging a battery-powered (BP) device such as a mobile or cellular telephone, portable digital video recorder (DVR), DVD player, navigation device, satellite radio, game device, mobile email terminal or PDA. The plug includes a plug body 15 (FIG. 1) which covers the components within the plug and provides a housing for the plug 10. In an embodiment, the plug body 15 may be shielded in order to provide for EMI/RFI shielding for the components within the plug 10. A front plate 20 provides an end plate to the plug body 15. A pair of power blades 21, 22 protrude from the front plate 20. In an alternate embodiment a third grounding blade or pin may also protrude from the front plate 20.

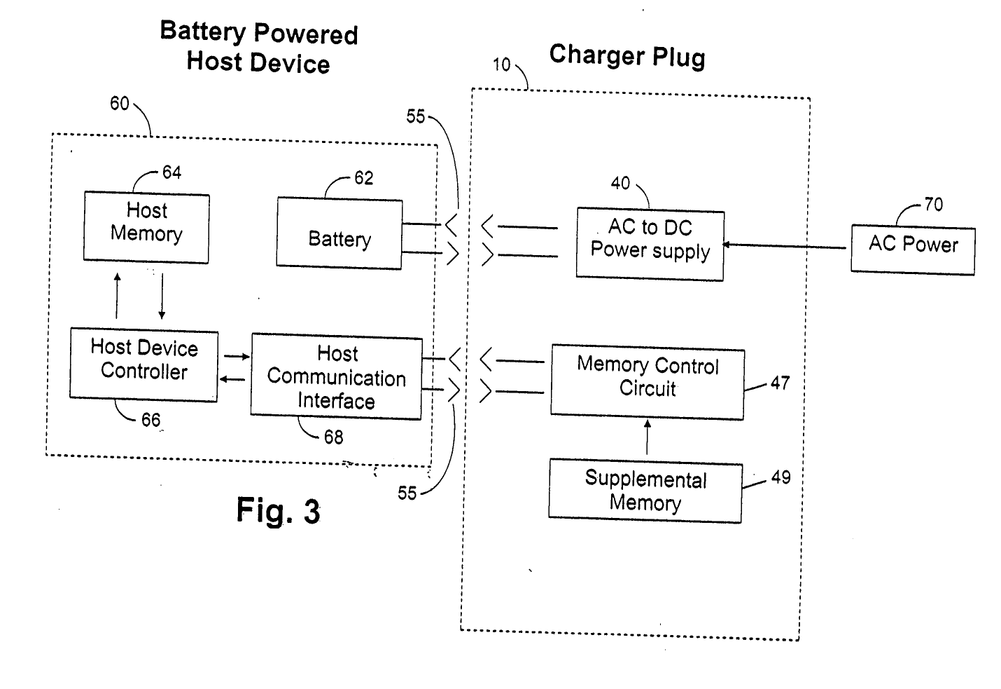

Mounted to the front plate 20 within the plug body 15 is a primary printed circuit board 25. Mounted to the printed circuit board 25 are the circuitry and components which operate the plug 10 and provide an AC to DC power supply 40 (FIG. 3) in order to provide, for example, a 6 volt DC 500 mA charger and memory backup functions. In a preferred embodiment, the printed circuit board 25 is double sided so that components may be mounted on both sides in order to provide for the small size of the plug and allow for a reduced contour for the plug body 15.

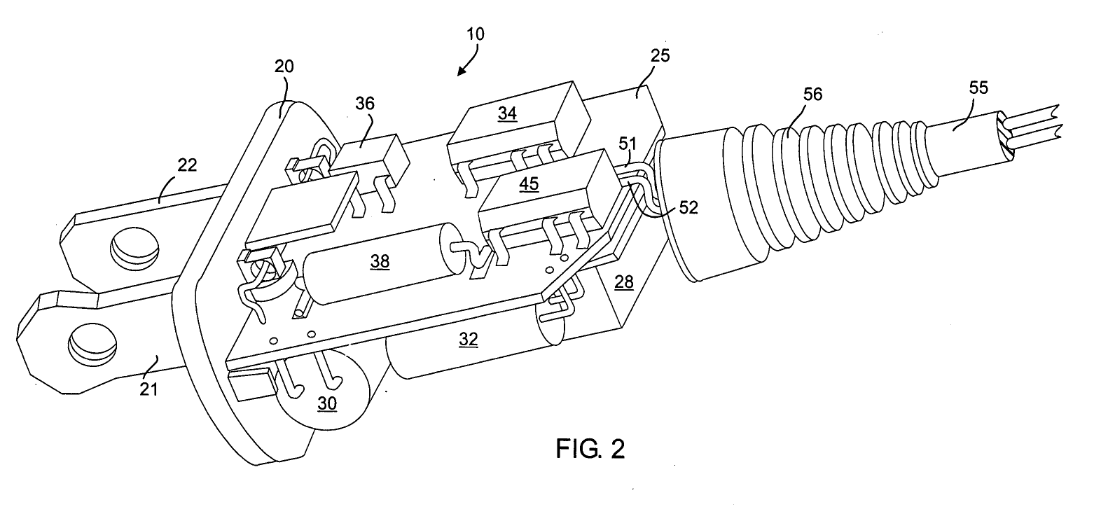

A transformer 28, capacitor 30 and capacitor 32 are provided on the first side of the printed circuit board 25 as shown in FIG. 1. FIG. 2 shows the opposite side of the printed circuit board 25 which includes power controller chip 34, diode bridge 36 and a fuse 38. All of such components and others not shown provide an AC to DC power supply 40, in order to provide for charging of a BP device from a standard electrical wall outlet 70. It is to be understood that FIGS. 1 and 2 are mere representations of components and circuits that may be present in the plug 10 and additional or alternate components and circuits may be provided that are known to those of skill in the art in order to provide the functionality described herein, such as converting an external voltage to a charging voltage and for supplemental memory.

The AC to DC power supply circuitry 40 acts to convert AC to DC and the charging circuit includes a power entry circuit, a 6-volt DC power supply incorporating an AC to DC conversion bridge connected to the receiving current from the power entry circuit and a DC/DC converter connected to the receiving power from the AC to DC conversion bridge. In an embodiment the DC/DC converter may contain a pulse modulation circuit activated by the circuit initiation voltage for the power control. The charging of the battery and functioning of the plug 10 including the AC to DC power supply 40 may be accomplished by various means. An example of the detailed functioning of such charging circuitry and construction of a plug may be found with reference to co-pending U.S. patent application Ser. No. 11/149,118 filed on Jun. 8, 2005, entitled “Compact Contour Electrical Converter Package,” which is incorporated herein by reference.

The plug 10 also includes a memory circuit 45 (FIG. 2). In an embodiment, a memory chip 45 includes a memory control circuit 47 and a supplemental or back-up memory, for example, supplemental memory 49 (FIG. 3). The memory control circuit 47 includes data flow regulation in order to control the data written to and retrieved from the supplemental memory 49 and to coordinate the data flow with the communication interface 68 of the BP device 60, described in more detail below.

The printed circuit board 25 is connected by contacts 51, 52 to a cable or cord 55. A strain relief 56 is provided between the connector of the cord 55 and the connectors 51, 52. The cord 55 has an extended body (not shown) and a plug connector (not shown) for connecting the plug 10 to a BP device, such as a cell phone, PDA, MP3 player or other such device 60. In a preferred embodiment, the cord 55 includes wires for carrying charging current to the BP device and also for transmitting memory data. In an alternate embodiment, the same charging current carrying wires concurrently function to transmit memory data. In an alternate embodiment, the transmission of data from the memory control circuit 47 of the plug 10 to the host communication interface 68 may be wireless. For example, an RFID or Bluetooth system may be provided with the plug 10 (cord 55) and BP device 60 in order to wirelessly transmit data to be written to the supplemental memory 49 or restored to the host memory 64.

The BP device 60, in an embodiment, includes a battery 62 which receives current from the cord 55 in order to charge the battery via the plug battery-charging circuitry 40. The BP device 60 may also include a battery controller in order to control the current received by the battery of the BP device 60. The BP device 60 may also include a host or main memory 64, a host device controller 66 and a host communication interface 68.

Commonly available BP devices have a substantial amount of information in memory. For example, cellular phones include data such as telephone numbers, names, addresses, calendars, ring tones, photographs and, in some cases, compressed files for music and video. Thus, the present invention provides for a means of supplementing or backing up data from the BP device memory 64 to the supplemental memory 49 of the plug 10. It is to be understood, that the supplemental memory 49 may store data that supplements the host memory 64 and/or duplicates data and acts as a back-up for the host memory 64. In an embodiment, the host communication interface 68 determines the status of the supplemental memory 49 of the plug 10 and acts to retrieve data from the host memory 64 via the host device controller 66 and write the data to the supplemental memory 49 via memory control circuit 47. In an alternate embodiment, the host device controller 66 determines the status of the supplemental memory 49 of the plug 10 and acts to retrieve data from the host memory 64 and send it to the host communication interface 68 and write the data to the supplemental memory 49 via memory control circuit 47. The host memory 64 may include but is not limited to working memory and data storage (e.g. SRAM or PSRAM), bootable storage memory (e.g. NOR Flash or EEPROM), multichip packaging (MCP) or additional memory (e.g. NAND Flash). One or all of these memory locations of the BP device 60 may be backed-up to the supplemental memory 49 of the plug 10. The memory control circuit 47 of the plug acts to control the transfer of the data in and out of the supplemental memory 49 of the plug 10.

In an embodiment, the supplemental memory 49 is a non-volatile solid state memory device such as an EEPROM or a flash memory EEPROM (electrically erasable programmable read only memory). In an alternate embodiment, a volatile or non-volatile ROM, RAM, or NVRAM may be provided. In an embodiment, more than 100 Mb of storage may be provided by the supplemental memory 49. For example, a multi-stacked MCP BGA (ball grid array) package may provide a large storage area for the supplemental memory 49. In an alternate embodiment, a micro-drive may be provided for storing larger amounts of data. In an embodiment, the supplemental memory or part of the supplemental memory 49 may be removable via a slot, door, or other opening in the housing 15 and be contained within a portable memory card or stick. Data is electronically written and erased to the memory location 49. In an embodiment, the memory control circuit 47 may also control the writing of host memory 64 data to the supplemental memory 49 only when plug 10 is powered by an electrical outlet. It may be possible to have the plug 10 connected only to the BP device 60 and not to an electrical outlet. In that case it may be preferred that the plug 10 does not drain the battery 62 of the BP device 60 in order to write data to the supplemental memory 49. Therefore, the memory control circuit 47 may have a switch that is actuated by the powering of the AC to DC power supply 40 to allow for the writing of data to the memory 49 during a period when the plug 10 is powered. In an alternate embodiment, the memory control circuit 47 may allow independent transfer of data to the supplemental memory 49, irregardless of the functioning of the AC to DC power supply 40. In this case the memory control circuit 47 and the supplemental memory 49 receive operating power from the battery powered host device 60 via cord 55 and from the host communication interface 68, the battery 62, or from a second battery housed within plug 10. The memory control circuit 47 may also perform matching of electrical characteristics and adjust signal timing.

It is to be understood that when the plug 10 is attached to the BP device 60, the data from the memory 64 is automatically backed-up or restored to the supplemental memory 49 of the plug 10. Each time the plug 10 is connected (via its connector and cord 55) to the BP device 60, the supplemental memory 49 may be erased and completely rewritten. Data from the host memory 64 may be completely rewritten to the supplemental memory 49 each time there is a new connection made between the plug 10 and the BP device 60. In an alternate embodiment, where use of a memory chip 45, such as a standard EEPROM can only be rewritten a limited number of times, only the new data provided in the host memory 64 may be backed-up in the supplemental memory 49, which may be coordinated by the host device controller 66, for example. In either event, the supplemental memory 49 may be large enough to contain all of the data that could possibly be contained in the various storage areas that comprise the host memory 64.

In the case where the BP device 60 malfunctions and the host memory 64 is either inaccessible or cannot be accessed, the host communication interface 68 or the host device controller 66 may be programmed to retrieve the data stored on the supplemental memory 49. In an alternate circumstance, the original BP device may become lost and a new BP device is purchased. The new compatible BP device may be connected to the plug 10 and the new BP device's host memory can be updated and restored with all of the data from the supplemental memory 49. If a BP device is lost, merely by purchasing a new BP device and attaching it to the existing plug 10, all of the telephone numbers, addresses, names and/or other data stored in the lost BP device may be quickly and easily restored to the host memory 64 of the new BP device.

In an alternate embodiment, the particular type of data to be stored in the supplemental memory 49 may be controlled via the host communication interface 68, or host device controller 66 which may be programmed by the BP device itself. The BP device 60 may allow the user to program the host device controller 66 in order to provide instructions for which data should be backed-up and how and when it should be backed-up or restored. By scrolling through menus provided by the BP device 60 and choosing certain options and functions, the control of the writing and reading of data to and from the supplemental memory 49 may be more particularly customized by the user with respect to the types of files or information to be backed-up and restored. Therefore, any data that the user of the BP device 60 does not want to update, store, or restore can be controlled via buttons and/or user interface of the BP device 60 to control the host communication interface 68. A user may accidentally erase or lose partial or all data on BP host device 60. In this case, the host device controller may be programmed to request user acknowledgement before replacing the contents of the supplemental memory 49 with that of the host memory 64 and/or provide options for restoring the lost data.

In an alternate embodiment, the plug 10 may contain a simple user interface such as one or more pushbutton switches and a multicolored LED or small display. The push buttons could initiate or control the storing of data to, and retrieval of data between the plug 10 and the BP device 60. The LED or display could report such data transmission progress or status. Such controls could be located on plug housing 15, front plate 20, attached to cord 55 or in the extended body connector which attaches cord 55 to the BP device 60.

The blades 21, 22 of the plug 10 may be inserted into a standard 120 VAC electrical wall outlet 70. For example, a standard NEMA 5-15P outlet includes an outlet face 71 providing a receptacle for the plug 10. The face 71 has a standard dimension d₁×d₂. For example, the face of the outlet receptacle 71 may have dimensions of 1_{1/4}×1_{1/4} inch. Thus, in an embodiment, the first dimension d₁=1_{1/4}, inch and the second dimension d₂=1_{1/4}. In the preferred embodiment, the plug body 15 provides an outer profile which has a dimension at its largest width of d₃ which is less than or equal to the first dimension d₁ of the face 71 of the outlet 70. In an embodiment, the plug body outer profile dimension at its largest width of d₃ and its largest height of d₇ is less than or equal to the first dimension d₁ and the second dimension d₂, respectively, of the face 71 of the outlet 70. Thus, in an embodiment, the entire outer profile or the plug 10 (including its width d₂ and its height d₇) is less than or equal to the peripheral dimension d₁, d₂ of the outlet face 71. It is to be understood that the outlet 70 may also include a receptacle of a surge protector bar or receptacle of an extension cord, each having one or more outlet faces. In an alternate embodiment, the faces 71, 73 may be non-polygonal and include arcuate sides or be circular.

It is also to be understood that the present invention, in an embodiment may have an outer profile that is less than or equal to the peripheral dimension d₁, d₂, even where the receptacle face 71 is smaller (e.g. the first dimension and second dimension are approximately 1.0 inch). In a further embodiment, the plug 10 is compact and may fit in a user's hand or be grasped by a user's hand so that the plug 10 may be easily connected via the blades 21, 22 to the electrical outlet 70. In an alternate embodiment, the blades 21, 22 may be pivotally mounted on the body 15 or may be indirectly attached to the body.

In another embodiment, the plug 10 has an outer profile d₃ ×d₇ that is larger than d₁ or d₂, but will not encroach on or obstruct the adjacent outlet face 73. For example, the second or adjacent face 73 may have dimensions of d₄ and d₅ (FIG. 1). In an embodiment, d₁=d₅ and d₂=d₄. As well, a gap or overhang area 75 is provided between the first face and the second face 71, 73. In an embodiment, where the outlet 70 may be a surge protector bar having multiple rows of outlets, each outlet face may have multiple gaps 75 provided between each face. In order not to interfere with the plugging area of the lower face 73, defined by the dimensions d₄×d₅, the plug 10 may have its widest outer dimension extend into the overhang area 75 but not beyond. Thus, the plug body 15 may have the additional width of d₆ added to its overall profile.

It is to be understood that in an alternate embodiment, the blade receiving apertures 76a,b, 77a,b may be rotated 90° and the width d₃ of the plug body 15 may extend into the overhang area (gap) 75 and the plug body 15 may extend up to the edge of the face 73 so that a second plug (not shown) having an outer profile of d₄×d₅ could still be attached to the outlet 70.

When the blades 21, 22 are inserted in the apertures 76a, 77a of the receptacle 70, the front plate 20 will abut against the face 71. The plug body 15 side walls form the plug outer profile and will extend perpendicularly from the face 71. In an embodiment, the outer profile d₃×d₇ of the front plate 20 and the plug body 15 will not extend beyond the dimension d₁×d₂ of the face 71 of the outlet 70. In this way, it is understood that the plug 10 may be inserted in the upper outlet 72, while leaving the lower or second outlet face 73 unencumbered and completely vacant, so that another plug or another device may be connected to the lower outlet face 73. Therefore, it is understood that the compact and small contour of the outer profile of the plug body 15 of the present invention allows for a convenient and portable charger plug 10 that can easily be plugged to a standard outlet 70.

The plug 10 of the present invention not only can be transported easily, but provides for automatic and/or manually controlled or programmed backup of data, as discussed above. Therefore, it is understood that a user of a BP device 60 may conveniently carry this small plug 10 and cord 55 in luggage, purse or a briefcase. When it comes time to charge the BP device 60, the user can easily find an open outlet 70 to connect the plug 10. For example, hotel room outlets may have many other devices plugged-in such as laptop computers, lamps or alarm clocks. It is inconvenient to have to begin to unplug such devices to make room for a cumbersome and large, “brick-sized” charger of previous known charging devices. Thus, it is understood that the present plug 10 provides for a charger which can be plugged into a standard outlet 70 on a wall or a surge protector bar without having to rearrange other plugs. The quick and easy attachment of the plug 10 will allow for charging of the BP device 60 and simultaneously automatically backup data to the plug 10.

In an alternate embodiment, the plug 10 may be a car adapter for charging a BP device in a vehicle through a lighter receptacle power outlet or accessory vehicle power socket). The blades 21, 22 discussed above may be disposed on a cylindrical male connector providing resilient contacts on the sides and end of the connector to convert 12 V power from the vehicle battery to charge the BP device such as a cell phone, PDA, portable DVR, DVD player, satellite radio, navigation device or game device. The memory control circuit 47 of the plug 10 may be customized to interact properly with each varying type of BP device. In such an alternate embodiment, the outer profile d₃×d₇ of the plug body of the vehicle plug charger may be substantially aligned to a standard vehicle power outlet dimension d₁ and d₂ (approximately 1 inch), in order to allow for easy plugging in a vehicle and ease of transport of the plug 10 and attached cord 55 in a purse or brief case.

The plug 10 may also include charging indicia that provide a visual or audible cue that indicates that the plug is charging. For example, an LED may be disposed on the plug body 15 and wired to the AC to DC power supply circuit 40 to be illuminated to indicate that charging of the BP device 60 is occurring. The plug 10 may also include other features and functionality, such as an authentication feature as described in co-pending U.S. Patent Application entitled, “Method and Apparatus to Authenticate Battery Charging Device” filed, Dec. 28, 2005, which is incorporated herein by reference.

While particular embodiments have been shown and described, it will be apparent to those skilled in the art that changes and modifications may be made without departing from the principles of the invention in its broader aspects. Details set forth in the foregoing description and accompanying drawings are offered by way of illustration only and not as a limitation. The actual scope of the present invention is intended to be defined in the following claims when viewed in their proper perspective based on the prior art.

1. A plug for charging a battery powered (BP) device comprising:
a plug body having an outer profile and mounted within the plug body is a charging circuit and a memory for receiving data sent from the BP device; and
power contact blades protruding from a front plate of the plug body, the power contact blades for connecting the charger to a standard electrical outlet including a face having a first dimension and the outer profile protruding generally perpendicular to the face, the outer profile being smaller than or equal to the first dimension.

2. The plug of claim 1 further including a memory control circuit for controlling data written to the memory.

3. The plug of claim 1 wherein the memory is a supplemental memory and the BP device is a cell phone that includes a host memory and a communication interface for writing data from the host memory to the memory of the plug.

4. The plug of claim 1 wherein the data includes telephone numbers, names, pictures, sound files, or other such data stored in a host memory of the BP device.

5. The plug of claim 1 wherein the BP device includes a communication interface that reads data from the memory.

6. The plug of claim 5 wherein the plug includes a memory control circuit and communication between the memory control circuit and the communication interface is wireless.

7. The plug of claim 1 wherein the memory is an EEPROM.

8. The plug of claim 1 further comprising a cord and connector for connecting the plug to the BP device and the cord for carrying DC to a battery of the BP device and data to a communication interface of the BP device.

9. The plug of claim 1 wherein the face of the outlet includes a second dimension and the first dimension and second dimension provide a peripheral dimension of the outlet face and the plug outer profile being smaller than or equal to the peripheral dimension.

10. The plug of claim 9 wherein the peripheral dimension includes an overhang area.

11. A method of charging a battery powered (BP) device comprising the steps of:
providing a host memory and battery in a BP device and a memory in a charger having a body;
grasping a plug body of the charger;
substantially aligning an outer profile of the body with an outer dimension of a standard electrical outlet;
connecting the charger to the standard electrical outlet by inserting blades of the plug body into the outlet so that the body outer profile does not extend substantially beyond the outer dimension of the standard electrical outlet;
attaching the charger to the BP device;
transferring current from the charger to the battery; and
automatically transferring data from the host memory to the charger memory.

12. The method of claim 11 wherein the BP device includes a communication interface and the charger includes a memory control circuit and the method further comprising the steps of:
writing data to the memory control circuit via the communication interface; and
transmitting data to the memory via the memory control circuit.

13. The method of claim 11 further comprising the step of:
converting AC to DC via an AC to DC conversion bridge.

14. The method of claim 11 wherein the transfer of data from the host memory to the charger memory occurs independently from the charging operation.

15. A cell phone charging system comprising:
a substantially standard sized electrical plug adapted to
convert AC, supply DC and charge a cell phone battery;
receive data from a data storage area of the cell phone; and
maintain data in a memory provided by the plug.

16. The system of claim 15 wherein the plug is adapted to connect to a standard electrical outlet having an outer dimension and the plug having a plug body substantially aligning with the outer dimension of the outlet.

17. The system of claim 16 wherein the outer dimension includes an overhang area.

18. The system of claim 15 wherein the cell phone includes a communication interface for transmitting data to the memory of the plug.

19. The system of claim 15 wherein the plug includes a printed circuit board (PCB) having a memory circuit a memory control circuit and a charging circuit.

20. The system of claim 19 wherein the memory circuit includes non-volatile ROM or RAM.

21. The system of claim 15 wherein an LED is disposed on the plug to indicate that the cell phone is charging.

22. The system of claim 15 further comprising an electrical switch disposed on the plug body, the switch for the purpose of controlling the transfer of data between the plug memory and the data storage area of the cell phone.

23. The system of claim 22 wherein the plug includes a plug body and an extended body connector for connecting a cord of the plug to the cell phone and the switch disposed on one of the plug body, cord and extended body connector.

24. The system of claim 23 wherein the switch is a pushbutton switch.

25. The system of claim 15 wherein the plug is adapted to connect to a vehicle electrical outlet in order to charge the cell phone from a battery of the vehicle.

26. A charger for a battery powered (BP) device comprising:
a plug body having a front plate;
a charging circuit and a memory disposed in the body, the memory for receiving data sent from the BP device; and
power contact blades protruding from the front plate, the power contact blades for connecting the charger to an electrical outlet.

27. The charger of claim 26 wherein the plug body includes an outer profile, the electrical outlet include a face having a first dimension and an overhang area adjacent the face and the outer profile of the plug body does not extend substantially beyond the overhang area.

28. The charger of claim 26 wherein the plug body includes an outer profile, the electrical outlet include a first face having a first dimension and a second face having a first dimension and the charger attached to the first face and the outer profile of the plug body does not obstruct the second face.

29. The charger of claim 28 wherein a gap is provided between the first and second face and the outer profile of the plug body does not extend substantially beyond the gap.

30. The charger of claim 26 wherein the power contact blades are pivotally attached to the front plate.

31. The charger of claim 26 wherein the plug body includes an outer profile, the electrical outlet including a face having a first dimension and the outer profile of the plug body does not extend substantially beyond the first dimension.

32. The charger of claim 31 wherein the face includes a second dimension and the outer profile of the plug body does not extend substantially beyond the second dimension.

33. The charger of claim 26 wherein the plug body, the front plate, charging circuit and memory comprise an integral package having a compact size that may be grasped by a users hand in order to plug the charger into the electrical outlet.

34. The charger of claim 26 further including a memory control circuit for controlling data written to the memory.

35. The charger of claim 26 wherein the memory is a supplemental memory and the BP device is a cell phone that includes a host memory and a communication interface for writing data from the host memory to the supplemental memory of the charger.

36. The charger of claim 26 wherein the data includes telephone numbers, names, pictures, sound files, or other such data stored in a host memory of the BP device.

37. The charger of claim 26 wherein the BP device includes a communication interface that reads data from the memory.

38. The charger of claim 26 wherein the charger includes a memory control circuit and communication between the memory control circuit and the communication interface is wireless.

39. The charger of claim 26 wherein the memory is an EEPROM.

40. The charger of claim 26 further comprising a cord and connector for connecting the charger to the BP device and the cord for carrying DC to a battery of the BP device and data to a communication interface of the BP device.

41. The charger of claim 26 wherein the memory is removable via an opening in the plug body and is contained within a portable memory card.
